(19) United States
(12) Patent Application Publication
(10) Pub. No.: US 2009/0179392 A1
(43) Pub. Date: Jul. 16, 2009

(54) SPORTING APPARATUS

(75) Inventor: Oskar Kuhbacher, Bolzano (IT)

Correspondence Address: Steinfl & Bruno, 301 N Lake Ave Ste 810, Pasadena, CA, 91101, US

(73) Assignee: New Invents GMBH - S.R.L., St. Pauls-Eppan(BZ) (IT)

(21) Appl. No.: 12/095,725

(22) PCT Filed: Dec. 1, 2006
(86) PCT No.: PCT/IB2006/545532

§ 371 Date: May 30, 2008

(30) Foreign Application Priority Data
Dec. 2, 2005 (IT) RM2005A000604

(51) Int. Cl. B62B 13/12; B62B 15/00; B62B 13/14

(52) U.S. Cl. 280/15; 280/28.11; 280/28; 280/22.1

(57) ABSTRACT

A sporting apparatus comprises at least two bases (1) apt to slide above a resting surface (100), connecting means (5) of the bases (1), apt to implement mutual motions of the bases (1) and characterized in that each one of the bases (1) comprises at least a projection (11), faced towards the resting surface (100).

The present invention relates to a sporting apparatus and, more generally, to a vehicle allowing to advance by sliding onto a surface.

A plurality of bobs, sledges, sleds and other means used for advancing by sliding onto a surface are known.

Generally, such means are used on the snow, so as to be able to descend from a slope or to be dragged by animals or motor vehicles.

However, it is clear that similar vehicles are used, more or less frequently, also onto other surfaces with respect to the snow-covered ones, for example onto the water or onto smooth grounds.

Nevertheless, the greatest part of such vehicles is commonly used for descending from snow-covered slopes, both for amusement purposes and for agonistic purposes.

In these cases, in order to allow at the same time high speeds, good manoeuvrability and safety for the driver, several constructive solutions have been studied.

Such solutions vary from the simplest and cheapest ones, the most extreme case is represented by a simple base made in plastic whereon one can seat, to technologically very advanced, and consequently very expensive, solutions like, for example, the competition bobs.

However, it is clear that the simplest solutions often do not succeed in guaranteeing a manoeuvrability and a safety sufficient for the user.

Nevertheless, more perfected solutions, even if they have several advantages with respect to the less evolved solutions, request quite complex, and consequently expensive, materials, components and implementations.

Furthermore, very often they are particularly bulky and therefore they cannot be easily transported.

An attempt of compromising between constructive simplicity and costs is represented by those bobs implemented by means of a sliding base, whereon a seat is obtained, and comprising two brakes, arranged on the two sides of the vehicle.

The brakes allow both to slow down and to direct the sporting apparatus, at least within certain limits.

In fact, it is clear that the simple fact of pivoting onto the ground with one single brake, even allowing the vehicle to turn, does not allow an efficient control of the vehicle.

Furthermore, such vehicles often are subjected to breakages, due to the fragility and the stresses thereto the brakes are subjected, in particular in the places wherein they are fastened to the sliding base.

In order to further obviate to such problems, however trying to keep low the costs, bobs and sleds have been developed wherein there are no brakes and they try to exploit the shifting of the driver's weight to turn.

For example, the International patent application WO 03 057545 describes a bob divided into two portions connected therebetween, linked by means of a hinge which allows moving easily the body weight from one side to the other of the vehicle.

However, also in this case, the vehicle's control is poor or absent, since the resting surface of the sporting apparatus is however too large and such turning technique, substantially copied from the skiing activity, reveals unefficient.

Therefore, the technical problem underlying the present invention is to provide a vehicle for sliding onto a surface allowing to overcome the drawbacks mentioned above with reference to the known art.

Such problem is solved by a sporting apparatus according to claim 1.

The present invention has some important advantages. The main advantage is that the sporting apparatus according to the present invention, even if it is simple and unexpensive to implement, as well as easily transportable, allows a perfect manoeuvrability, also at high speeds, with a consequent high safety for the driver.

Furthermore, the sporting apparatus according to the present invention is bulky in a particularly reduced way so as to be able to be transported easily.

Other advantages, features and application modes of the present invention will result clear from the following detailed description of some embodiments, illustrated by way of example and not for limitative purpose. The figures of the enclosed drawings will be referred to, wherein:

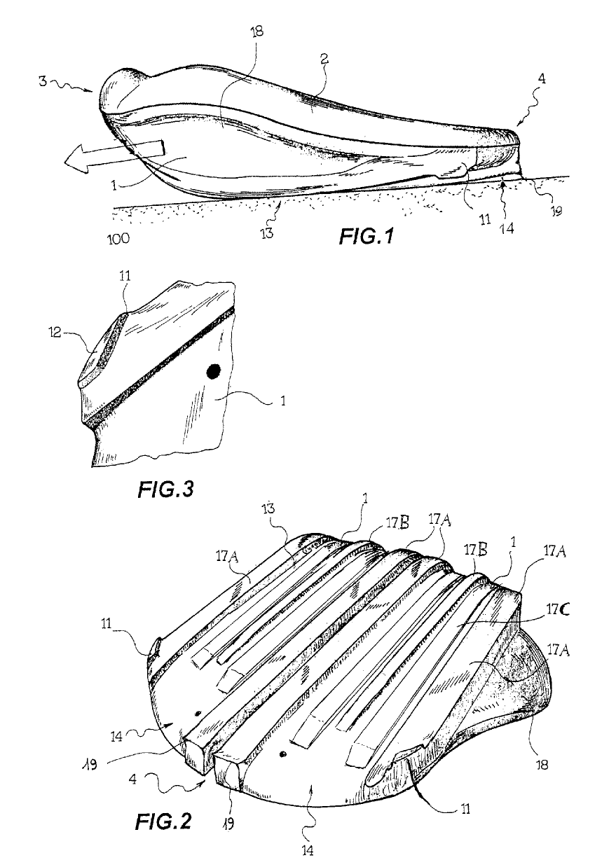

FIG. 1 is a side view of the sporting apparatus according to the present invention which illustrates the advancing direction thereof onto a surface;

FIG. 2 is a bottom perspective view of the sporting apparatus of FIG. 1;

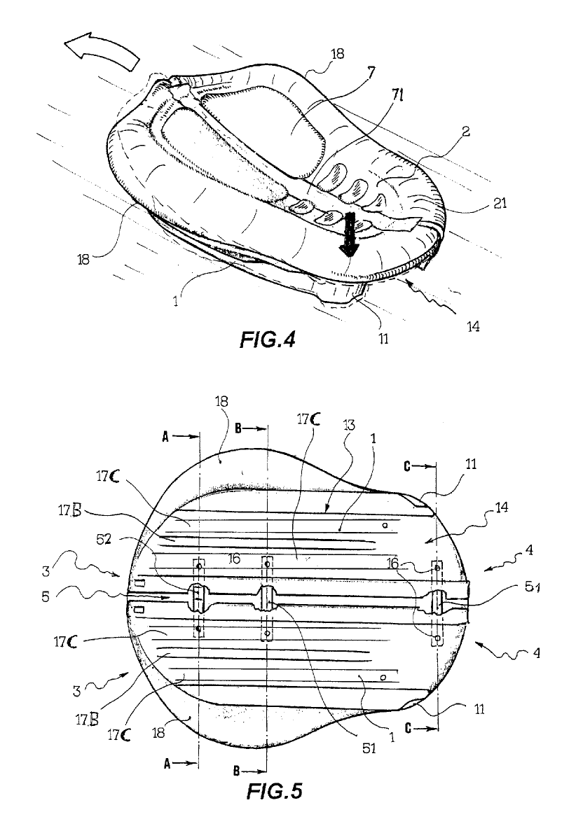

FIG. 3 is a perspective view of a projection, detail of FIG. 2;

FIG. 4 is a top perspective view of the sporting apparatus of FIG. 1;

FIG. 5 is a bottom, partially cross-section view illustrating two bases and related connection means between the same, details of the sporting apparatus of FIG. 1;

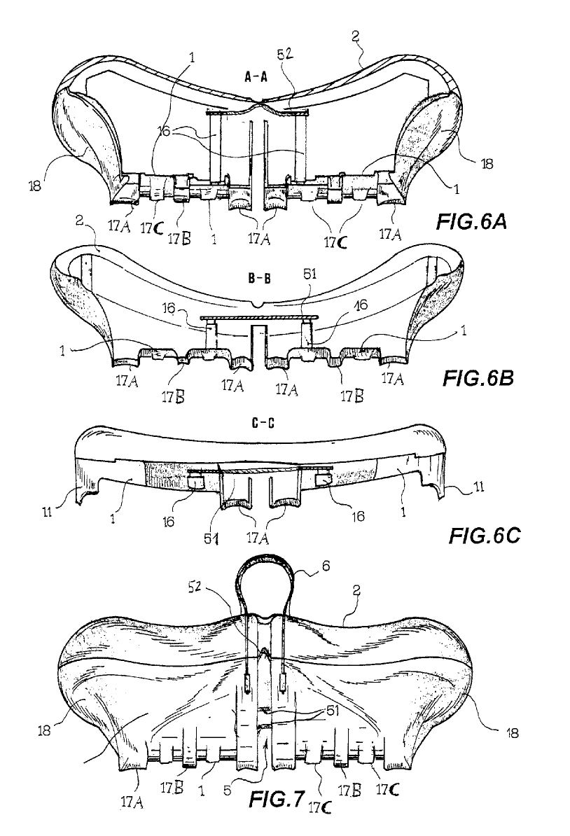

FIGS. 6A, 6B and 6C are three front sections of the sporting apparatus according to the present invention illustrating the connecting means of FIG. 4 and of sliding members;

FIG. 7 is a front view of the sporting apparatus according to the present invention; and

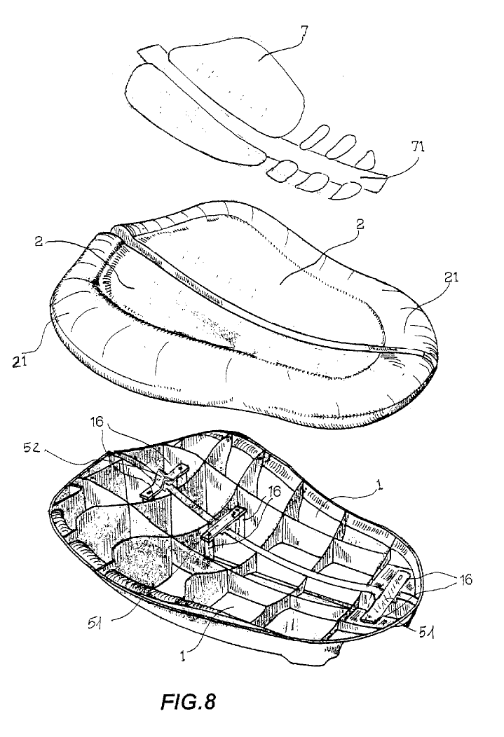

FIG. 8 is an exploded, perspective view of the sporting apparatus according to the present invention.

By firstly referring to FIG. 1, a sporting apparatus comprises two bases 1 which, as it will be seen in detail hereinafter, during the apparatus' use slide onto a resting surface 100.

Above each base 1 a respective seating plane 2 is placed, illustrated in FIG. 4, shaped in an anatomic way, wherein the user seats during the apparatus' use. Above the seating planes 2, as it will be better illustrated hereinafter, there is furthermore a soft covering 7.

According to the present embodiment, the resting surface 100 is represented by a blanket of snow or ice, but it has to be understood that the sporting apparatus could be used, with simple structural modifications, also onto other surfaces, such as water or other grounds.

By referring to FIG. 2, onto each one of the bases 1 there are two projections 11, which project from the bases 1 in direction substantially perpendicular to the same.

As it will be explained in detail hereinafter, the projections 11 act by allowing the apparatus to turn.

To this purpose, the projections 11 have sizes so as to be able to be partially driven into the surface 100, if it is represented by sufficiently soft snow, or however to create a friction effect with the same, in case it is frozen or not able to allow the projections to penetrate.

For this reason, the projections 11 will not have to show excessive sizes, however without risking to be damaged during the motion of the sporting apparatus. Based upon such considerations, the sizing of such projections can be implemented, in case even by experimental way, by a person skilled in the art.

In any case, still according to a preferred embodiment, the projections 11 have a flat end surface 12, since they have not the aim of penetrating into the ground wholly, but only partially or at all, in case of friction, since, as it will be seen hereinafter, the turning action, differently from the sleds manufactured according to the known art, is not implemented by the action of the projections only.

By referring again to FIG. 1, the bases have a plane portion 13, which during the use of the sporting apparatus is substantially parallel to the surface 100 and rested thereon and a tilted portion 14, thereat the projections are placed so as to be slightly lifted from the surface 100 with respect to the plane portion 13. In other words, the projections, being fastened to the tilted portion 14, during the rectilinear motion of the apparatus, are at greater distance from said surface 100 with respect to the plane portion 13.

For a correct operation of the sporting apparatus, the advancing direction, marked in FIG. 1 by an arrow, is so that the projections 11 and the tilted portion 14 are placed in the rear part of the sporting apparatus, the part opposed to the advancing direction under rear part being meant.

In this way respective front ends 3 and rear ends 4 of the sporting apparatus remain defined.

For an optimum operation of the sporting apparatus, the projections 11 are placed proximate the rear end. Such feature allows the maximum guidability and control.

The tilted portion 14 further comprises an edge 19 providing help in the breaking operations of the apparatus according to the present invention.

The edges 19, in fact, allow to break, by driving into the ground when the user's weight is brought backwards and the front end 3 lifted.

By then referring to FIG. 5, the bases 1 are connected therebetween by specific connection means 5.

In particular, the connections means 5 is implemented by flexible members, so as to allow a revolving connection between the two bases.

The connection means between the bases, in particular, is apt to keep them parallel therebetween when the sporting apparatus advances in rectilinear direction and, at the same time, allows limited rotation and translation motions between the two bases, so as to allow the sporting apparatus to turn.

In fact, by referring to FIG. 4, the two bases can perform limited related rotation and translation motions therebetween, so that these motions allow moving toward the surface 100 the rear end 4 of one of the two bases, allowing the respective projection 11 to drive or to implement the friction effect described previously. The implemented motion is represented schematically in figure by means of a sketched line.

Such shifting of the base 1 can be implemented by the user by exerting a force with the weight of his/her own body, force illustrated in figure by an arrow, onto the base 1 corresponding to the side wherein one wishes to turn.

The curvilinear motion is implemented not only by means of the action of the projection 11, which acts as brake onto the surface 100, as it is pushed downwards by the imparted force, but also by the action of the weight acting in general onto the base, since analogously to what happens in the skiing practice, it allows creating a pivoting action and taking the curvilinear trajectory.

In skiing, in fact, the legs' independence allows alternating the weight onto one of the sides, by lightening onto the opposite one, so as to turn easily and with the maximum control.

The action which is performed by the connection means 5 allows obtaining a similar action as the two bases are partially independent.

In order to understand in detail the dynamics of the used motion, the connection means used in the present embodiment is described in detail hereinafter.

In fact, by referring to FIG. 5, the bases are separated and joined therebetween by means of the flexible members, existing in a number equal to three.

Such flexible members connect respective side ends of the bases 1, so as to keep them substantially parallel therebetween during the advancing of the sporting apparatus.

In greater detail, first flexible members 51 are placed at the rear end 3 of the apparatus and in a substantially central area of the same, whereas a second flexible member is arranged at the front end 4.

By referring to FIGS. 6A-6C, the first flexible members have a lower longitudinal extension with respect to the one of the second flexible member.

However, as it can be noted again in FIG. 5, the flexible members are fastened by means of respective pairs of pins 16, all arranged at the maximum distance therebetween.

Consequently, as it can be clearly seen in FIG. 6A, the second flexible member will have a greater extension than the distance between the pins 16 thereto it is fastened and, consequently, in such position, the bases will have greater freedom of movement as they are not constrained.

However, the presence of the first flexible members 51, as mentioned previously, keeps the bases parallel and, being flexible, they allow the bases to approach therebetween, by limiting the possibility of splitting and also allow limited rotation and translation motions in the other directions.

The second flexible member 52, having instead a greater extension, allows greater motion freedom at the front end 4.

This feature, together with the flexibility of other flexible members, allows obtaining the motion described before, wherein the projection moves towards the surface 100 further to the action of the user's weight.

More precisely, the front end of each base can lift and allow the base to make a roto-translating motion, so as to make the projection to move towards the resting surface. To this purpose it is to be noted that also the projections, being fastened to the tilted portion, usually are not in contact with the surface 100, since they are more distant therefrom with respect to the plane portion 13, whereas they approach further to the here-described motion.

The use of such connection means allows a perfect manoeuvrability of the apparatus which translates into very easy capability in facing the curves and in a high control of the same.

Such effect is implemented both by the use of the projection 11, and by the possibility of moving the weight offered by the flexible members.

Furthermore, the presence of the plane portion 13, which keeps in contact with the surface 100 during the apparatus' advancement, counterposed to the tilted position 14 which can approach the surface so as to make the projection to penetrate, allows again the combined action of weight and projection for the apparatus control.

Still with the purpose of contributing to the vehicle control, the bases 1 are also equipped with specific overhangs 17A, 17B and 17C which extend longitudinally under the bases 1, resting with the surface 100.

The overhangs have different features therebetween and in particular there are first overhangs 17A implemented arranged at both sides of the bases 1, second overhangs 17B arranged substantially centered onto the bases 1 and third overhangs 17C interposed to the first and second overhangs. The first, second and third overhangs 17A, 17B, 17C have a depth decreasing therebetween, in other words the first overhangs 17A project more from the bases towards the surface 100 with respect to the second ones 17B and these ones more with respect to the third ones 17C.

The bases 1 then rest only partially to the surface 100 by means of the above-mentioned overhangs which, having a substantially elongated development, define a preferential direction for the advancement.

Furthermore, the applicant has experimentally noted that the sporting apparatus has a greater stability, as well as a better control upon turning, if it rests onto the concave overhangs 17 instead of being wholly in contact with the surface 100.

In particular, according to the present embodiment, there are three overhangs 17 for each base 1, two arranged at respective ends and one centrally, interposed to the first two.

By further referring to FIGS. 6A-6C and 7, the overhangs 17A have a surface in contact with the concave surface 100. Such feature allows improving more the stability in the trajectory taken by the apparatus since it allows a better penetration into the surface 100 also in case of presence of ice or compact and hard snow.

Furthermore, it keeps the apparatus stabler upon turning by avoiding, or however limiting, side skidding of the same.

The overhangs 17 can be implemented onto the bases by means of molding or, according to a preferred embodiment, they are manufactured in metallic materials and fastened to the same.

Furthermore, it can be noted that the bases 1 can be easily made of plastic materials by means of molding. Such feature reveals particularly advantageous, since it allows a simple and economic implementation of the apparatus according to the present invention.

The possibility of using overhangs 17 which can be applied separately to the bases 1, and with a more resistant material with respect to the plastic therewith they are implemented, reveals to be just as advantageous. Furthermore, also the projections 11 can be integrated to the overhangs and therefore they, too, can be manufactured with metallic materials or however particularly resistant materials. Such aspect is desirable since, as explained previously, the projections are subjected to strong stresses during the use of the sporting apparatus and in this way they can be also replaced in case of excessive wear.

Furthermore, the front end 3 of the sporting apparatus according to the present invention is conveniently raised, so as to provide a comfortable driving position.

In fact, in the bobs according to the known art the traditional seating position results to be uncomfortable, since it is necessary to keep the legs raised during the vehicle advancing.

The presence of the a raised front end 3 allows to support the legs during the use of the apparatus according to the present invention, without however compromising the possibility of using the feet to slow down or however to improve the vehicle control.

The rear end 4, instead, is lower since it advantageously allows to keep both a seated position and to stretch out, by bringing backwards ones' back, so as to be in more aerodynamic position and to be able to advance at higher speeds. It is clear that the vehicle control in this case has a greater importance, since the traditional bobs and sleds, not allowing an adequate control, become dangerous when one wishes to proceed at high speeds.

The sporting apparatus according to the present invention further comprises handles 18 obtained, in particular, onto the bases 1.

Such handles allow on one side to better grasp the apparatus, but above all they facilitate the act of shifting the user's weight in a base instead of onto the other one during the advancing in a curvilinear direction.

Furthermore, it is to be noted that also the handles 18, being implemented directly onto the bases 1, contribute to obtain a structure which is at the same time resistant and simple to be implemented.

By then referring to FIGS. 4 and 8, the seating planes 2 have a frame 21 shaped so as to create a space inside thereof the user can be housed. The seating planes 2 are separated therebetween, so as not to hinder the motions of the bases 1 and they are covered by the covering 7, so as to increase the user comfort.

In particular, according to the present embodiment, the covering 7 has a central flexible region 71, which does not hinder the motions of the bases described previously.

This constructive solution allows a softer and more comfortable seating and to protect the user from snow splashes which could come from the space existing between the two bases.

Furthermore, it allows keeping stabler the bases, both during the use and also during the transportation of the apparatus.

At last, by now referring to FIG. 7, the apparatus can also comprise a lace 6 for transporting the same and for better supporting the trunk weight during the descending phase with a more aerodynamic corporeal position, fastened to the bases 1.

According to a different embodiment, not illustrated in figure, the sporting apparatus can further comprise a central portion on the sides thereof the bases mentioned above are fastened.

It is clear that in this case the connection means will implement a connection so as to allow the independent motion of the two bases with respect to the central portion.

In each case such motions have the purpose of allowing the projections to penetrate into the resting surface and to allow to go along a curvilinear trajectory.

The present invention has been described sofar by referring to preferred embodiments. It is to be meant that other embodiments may exist belonging to the same inventive core, all however comprised within the protective scope of the herebelow reported claims.

1. A sporting apparatus comprising
at least two bases adapted to slide above a resting surface, and
connection means of said bases, adapted to implement limited mutual motions of said bases,
wherein each one of said bases comprises at least a projection, arranged proximate a rear end of said bases, so that said connection means be adapted to implement approaching of said projections to said resting surface.

2. The sporting apparatus according claim 1, wherein said connection means allows partial translation and rotation motions of said bases, so as to allow the approaching of said projections to said resting surface.

3. The sporting apparatus according to claim 1, wherein said projections are adapted to approach to the resting surface further to the action of a user's body weight at one of said bases.

4. The sporting apparatus according to claim 1, wherein said projections have a flat end surface.

5. The sporting apparatus according to claim 1, wherein said projections have a tapered section.

6. The sporting apparatus according to claim 1, wherein said connection means comprises at least a first flexible member adapted to keep said bases substantially parallel therebetween during advancing of the sporting apparatus and at least a second flexible member with a greater length than said at least a first member.

7. The sporting apparatus according to claim 6, further comprising two first flexible members arranged substantially at said projections and at a central area of said bases, wherein said at least a second flexible member is substantially proximate a front end of said bases.

8. The sporting apparatus according to claim 1, wherein said bases comprise overhangs adapted to slide onto said resting surface.

9. The sporting apparatus according to claim 8, wherein said overhangs are arranged next to said bases and have a concave surface in contact with said resting surface.

10. The sporting apparatus according to claim 1, wherein said bases comprise a plane portion, substantially parallel to said resting surface and a tilted portion, said projections being arranged at said tilted portion.

11. The sporting apparatus according to claim 10, wherein said projections are at a greater distance from said surface with respect to said plane portion.

12. The sporting apparatus according to claim 1, wherein said bases comprise an edge adapted to provide help during braking operations.

13. The sporting apparatus according to claim 1, comprising two seating planes and a soft covering.

14. The sporting apparatus according to claim 13, wherein said soft covering comprises a flexible central region.

15. The sporting apparatus according to claim 1, wherein said bases comprise handles adapted to grasp the sporting apparatus.

16. The sporting apparatus according to claim 1, comprising a central portion connected to said bases by means of said connection means.
